(19) United States
(12) Patent Application Publication
(10) Pub. No.: US 2017/0021830 A1
(43) Pub. Date: Jan. 26, 2017

(54) ADAPTIVE CRUISE CONTROL PROFILES

(71) Applicant: GM GLOBAL TECHNOLOGY OPERATIONS LLC, Detroit, MI (US)

(72) Inventors: DMITRIY FELDMAN, WEST BLOOMFIELD, MI (US); STEVE K. DOBOS, LAPEER, MI (US); MOHAMED M. NASSER, DEARBORN, MI (US); JERRY D. GREEN, ORTONVILLE, MI (US)

(21) Appl. No.: 14/806,030

(22) Filed: Jul. 22, 2015

(51) Int. Cl. B60W 30/14

(52) U.S. Cl. CPC B60W 30/14

(57) ABSTRACT

Methods and systems for controlling an adaptive cruise control feature of a vehicle are provided. In accordance with one embodiment, a system includes a sensing unit and a processor. The sensing unit is configured to detect passengers, other than a driver, in a vehicle. The processor is coupled to the sensing unit. The processor is configured to at least facilitate controlling an adaptive cruise control feature of the vehicle using a first profile if no passengers are detected in the vehicle, and a second profile, different from the first profile, if one or more passengers are detected in the vehicle.

### TECHNICAL FIELD

The present disclosure generally relates to vehicles, and more particularly relates to methods and systems for controlling adaptive cruise control systems for vehicles.

### BACKGROUND

Many vehicles today utilize cruise control systems, for example in which a vehicle may maintain a constant speed as requested by a driver of the vehicle. Certain vehicles include adaptive cruise control features, in which the vehicle makes adjustments as appropriate, for the speed of the vehicle. For example, certain vehicles include a full speed range adaptive cruise control (FSRACC) feature, in which the vehicle is makes adjustments, as appropriate, to the speed of the vehicle, including bringing the vehicle to a complete stop when appropriate. It may be desired to further customize adaptive cruise control features, such as FSRACC features, for a driver of the vehicle.

Accordingly, it is desirable to provide techniques for controlling adaptive cruise control features, such as FSRACC features, of vehicles. It is also desirable to provide methods, systems, and vehicles utilizing such techniques. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method is provided. The method comprises detecting passengers, other than a driver, in a vehicle; and controlling an adaptive cruise control feature of the vehicle using a first profile if no passengers are detected in the vehicle, and a second profile, different from the first profile, if one or more passengers are detected in the vehicle.

In accordance with another exemplary embodiment, a method is provided. The method comprises identifying a driver of a vehicle, obtaining a driving history for the driver, and controlling an adaptive cruise control feature of the vehicle using the driving history for the driver.

In accordance with a further exemplary embodiment, a system is provided. The system comprises a sensing unit and a processor. The sensing unit is configured to detect passengers, other than a driver, in a vehicle. The processor is coupled to the sensing unit. The processor is configured to at least facilitate controlling an adaptive cruise control feature of the vehicle using a first profile if no passengers are detected in the vehicle, and a second profile, different from the first profile, if one or more passengers are detected in the vehicle.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for an adaptive cruise control feature for the vehicle, in accordance with an exemplary embodiment; and

FIG. 2 is a flowchart of a process for controlling an adaptive cruise control feature, and that can be used in connection with the vehicle of FIG. 1, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

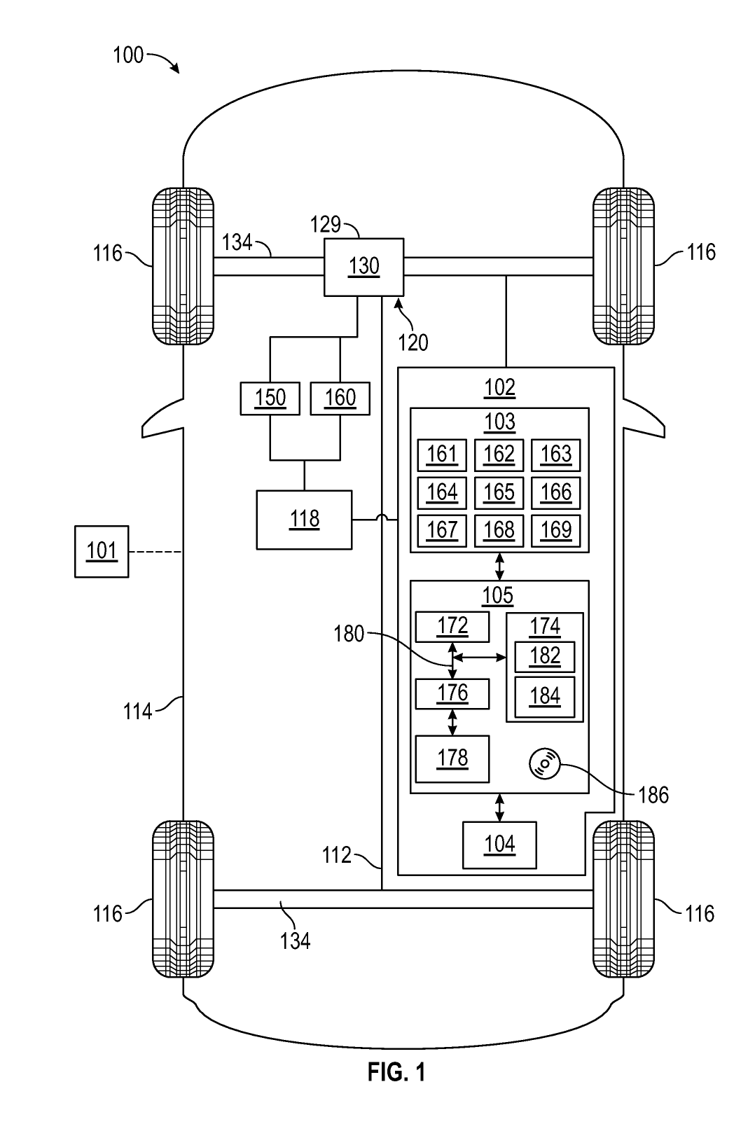

FIG. 1 illustrates a vehicle 100, or automobile, according to an exemplary embodiment. The vehicle 100 is depicted alongside a communication device 101 (such as a user key fob) through which the vehicle 100 and a driver of the vehicle 100 may communicate. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD).

As described in greater detail further below, the vehicle 100 includes a control system 102 for controlling an adaptive cruise control feature for the vehicle 100. As discussed further below, the control system 102 includes a sensor array 103, a transceiver 104, and a controller 105 that are used in controlling the adaptive cruise control feature. In various embodiments, the controller 105 controls the adaptive cruise control feature via the selection of a driver profile from a plurality of stored driver profiles based on whether other passengers are detected in the vehicle 100 and/or based on a driving history for the current driver of the vehicle 100.

As depicted in FIG. 1, the vehicle 100 includes, in addition to the above-referenced control system 102, a chassis 112, a body 114, four wheels 116, an electronic control system 118, a steering system 150, and a braking system 160. The body 114 is arranged on the chassis 112 and substantially encloses the other components of the vehicle 100. The body 114 and the chassis 112 may jointly form a frame. The wheels 116 are each rotationally coupled to the chassis 112 near a respective corner of the body 114. In various embodiments the vehicle 100 may differ from that depicted in FIG. 1. For example, in certain embodiments the number of wheels 116 may vary. By way of additional example, in various embodiments the vehicle 100 may not have a steering system, and for example may be steered by differential braking, among various other possible differences.

In the exemplary embodiment illustrated in FIG. 1, the vehicle 100 includes an actuator assembly 120. The actuator assembly 120 includes at least one propulsion system 129 mounted on the chassis 112 that drives the wheels 116. In the depicted embodiment, the actuator assembly 120 includes an engine 130. In one embodiment, the engine 130 comprises a combustion engine. In other embodiments, the actuator assembly 120 may include one or more other types of engines and/or motors, such as an electric motor/generator, instead of or in addition to the combustion engine.

Still referring to FIG. 1, the engine 130 is coupled to at least some of the wheels 116 through one or more drive shafts 134. In some embodiments, the engine 130 is mechanically coupled to the transmission. In other embodiments, the engine 130 may instead be coupled to a generator used to power an electric motor that is mechanically coupled to the transmission. In certain other embodiments (e.g. electrical vehicles), an engine and/or transmission may not be necessary.

The steering system 150 is mounted on the chassis 112, and controls steering of the wheels 116. The steering system 150 includes a steering wheel and a steering column (not depicted). The steering wheel receives inputs from a driver of the vehicle 100. The steering column results in desired steering angles for the wheels 116 via the drive shafts 134 based on the inputs from the driver. Similar to the discussion above regarding possible variations for the vehicle 100, in certain embodiments the vehicle 100 may not include a steering wheel and/or steering. In addition, in certain embodiments, an autonomous vehicle may utilize steering commands that are generated by a computer, with no involvement from the driver.

The braking system 160 is mounted on the chassis 112, and provides braking for the vehicle 100. The braking system 160 receives inputs from the driver via a brake pedal (not depicted), and provides appropriate braking via brake units (also not depicted). The driver also provides inputs via an accelerator pedal (not depicted) as to a desired speed or acceleration of the vehicle, as well as various other inputs for various vehicle devices and/or systems, such as one or more vehicle radios, other entertainment systems, environmental control systems, lighting units, navigation systems, and the like (also not depicted). Similar to the discussion above regarding possible variations for the vehicle 100, in certain embodiments steering, braking, and/or acceleration can be commanded by a computer instead of by a driver.

The control system 102 is mounted on the chassis 112. As discussed above, the control system 102 controls an adaptive cruise control feature of the vehicle 100. In one embodiment, the control system 102 controls a full speed range adaptive cruise control feature for the vehicle 100. As referred to herein, a “cruise control” feature allows the vehicle to maintain a particular speed as requested by a driver of the vehicle. Also as used herein, an “adaptive cruise control” feature allows the vehicle to make adjustments as appropriate, for the speed of the vehicle. In addition, as used herein, a “full speed range adaptive cruise control” (FSRACC) feature allows the vehicle to make adjustments, as appropriate, to the speed of the vehicle, including bringing the vehicle to a complete stop when appropriate.

The sensor array 103 includes various sensors (also referred to herein as sensor units) that are utilized to calculate a velocity of the vehicle using different techniques. In the depicted embodiments, the sensor array 103 includes one or more driver identification sensors 161, passenger detection sensors 162, accelerometers 163, speed sensors 164, brake pedal sensors 165, accelerator pedal sensors 166, steering angle sensors 167, object detection sensors 168, and adaptive cruise control sensors 169. The measurements and information from the various sensors of the sensor array 103 are provided to the controller 105 for processing.

The driver identification sensors 161 include sensors or other apparatus for identifying a current driver of the vehicle 100. In various embodiments, the driver identification sensors 161 may include one or more sensors or other devices used to identify the current driver of the vehicle 100 based on one or more techniques, such as, by way of example, identifying which driver the communication device (e.g. keyfob) 101 currently in use belongs to, engagement of an input by the driver to identify the driver (e.g. the driver clicking a button to identify himself or herself or identifying oneself on an input screen), determining one or more physical characteristics of the current driver (e.g. fingerprint, height, weight, seat setting preference, or the like) and comparing it to known physical characteristics of the plurality of drivers of the vehicle 100, and so on. In certain embodiments, the identification of the driver is used to select a driver profile for the adaptive cruise control feature for the vehicle 100.

The passenger detection sensors 162 detect one of more passengers in the vehicle 100. As referred to herein, a “passenger” refers to any person currently inside the vehicle 100 (e.g. sitting on passenger seats inside the vehicle 100), other than the current driver of the vehicle 100. In various embodiments, the passenger detection sensors 162 may include, by way of example, one or more seat belt sensors (e.g. that detect the engagement of a seat belt device, such as when the seat belt is buckled or otherwise applied to a passenger) and/or sensors coupled to a passenger seat of the vehicle (e.g. a sensor disposed underneath a passenger seat that detects the presence, e.g. by weight against the passenger seat, of a passenger sitting in the passenger seat). In one embodiment, each seat includes such a seat sensor. In certain embodiments, the detection of passengers is used to select a driver profile for the adaptive cruise control feature for the vehicle 100.

The accelerometers 163 measure an acceleration of the vehicle 100, and the speed sensors 164 measure one or more speed values pertaining to a speed of the vehicle 100. In one embodiment, the speed sensors 164 comprise wheel speed sensors that measure wheel speeds, which are then used to determine the vehicle speed. In various embodiments, the acceleration and speed values are used to develop profiles for the various drivers of the vehicle and for controlling the adaptive cruise control feature.

The brake pedal sensors 165 are used to measure a driver's engagement of the brake pedal of the braking system 160. In various embodiments, the brake pedal sensors may comprise one or more brake pedal force sensors (that measure an amount of force applied by the driver against the brake pedal) and/or brake pedal travel sensors (that measure a distance travelled by the brake pedal when engaged by the driver). In various embodiments, such measures of brake pedal engagement by the driver are used to develop profiles for the various drivers of the vehicle and for controlling the adaptive cruise control feature.

The accelerator pedal sensors 166 are used to measure a driver's engagement of the accelerator pedal of the vehicle 100. In various embodiments, the accelerator pedal sensors 166 may comprise one or more accelerator pedal force sensors (that measure an amount of force applied by the driver against the accelerator pedal) and/or accelerator pedal travel sensors (that measure a distance travelled by the accelerator pedal when engaged by the driver). In various embodiments, such measures of accelerator pedal engagement by the driver are used to develop profiles for the various drivers of the vehicle and for controlling the adaptive cruise control feature.

The steering angle sensors 167 are used to measure a driver's steering of the vehicle 100 and/or the driver's engagement of the steering wheel or steering column of the steering system 150. In various embodiments, the steering angle sensors 167 may comprise one or more steering wheel sensors, steering column sensors, and/or wheel sensors that directly or indirectly measure a driver's steering of the vehicle 100 and/or the driver's engagement of the steering wheel or steering column of the steering system 150. In various embodiments, such steering angle values are used to develop profiles for the various drivers of the vehicle and for controlling the adaptive cruise control feature.

The object detection sensors 168 are used to detect objects (e.g. other vehicles or other objects) that may be in proximity to the vehicle 100 and/or to a path of the vehicle 100. In various embodiments, the object detection sensors 168 may comprise one or more radar, side blind radar, other radar, lidar, sonar, camera, laser, ultrasound, and/or other sensors and/or other devices. In various embodiments, the object detection values are used to develop profiles for the various drivers of the vehicle and for controlling the adaptive cruise control feature.

The adaptive cruise control sensors 169 determine whether the driver has engaged the adaptive cruise control feature of the vehicle 100. In various embodiments, the adaptive cruise control sensors 169 may comprise an adaptive cruise control button and/or screen selection sensor, among other possible sensors or other devices.

In certain embodiments, the transceiver 104 obtains data from one or more other systems or devices. In one example, the transceiver 104 obtains data from the communication device (e.g. keyfob) 101 (for example, when the driver unlocks the vehicle doors, remotely starts the engine, and/or remotely starts the signal) via one or more signals sent from the communication device 101. In various embodiments, the identification of the driver is used to generate, update, and select profiles for the various drivers of the vehicle and to control the adaptive cruise control feature.

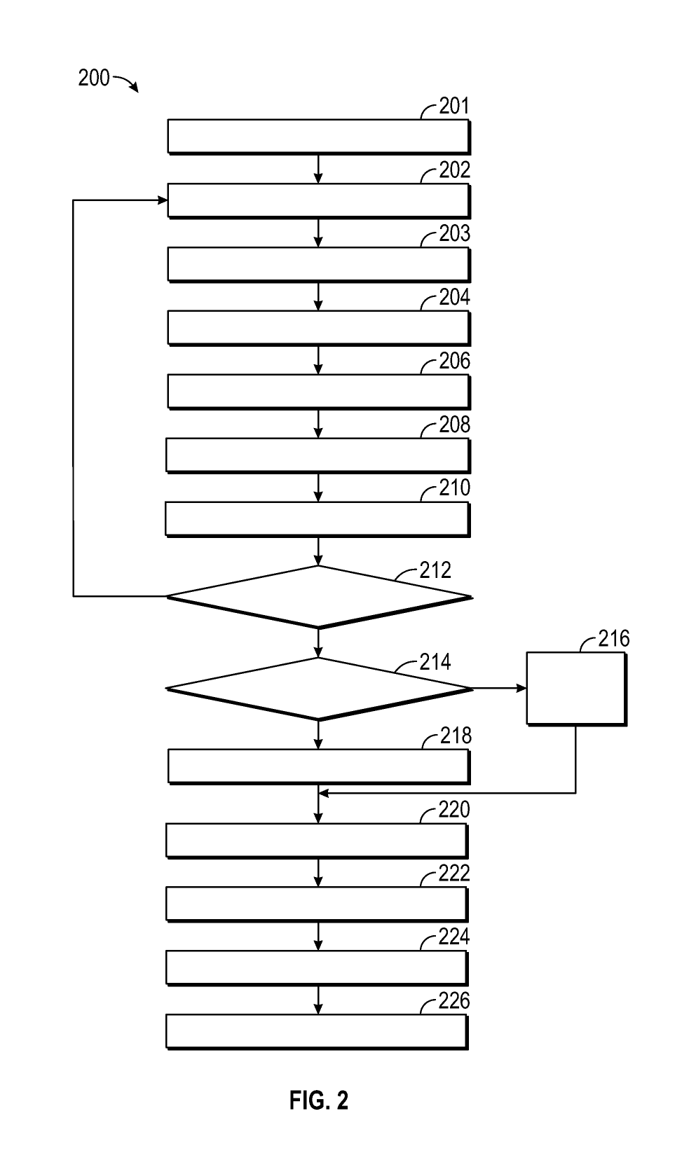

The controller 105 is coupled to the sensor array 103 and to the transceiver 104. The controller 105 utilizes the various measurements and information from the sensor array 103 and the transceiver 104 for developing and selecting driver profiles for the adaptive cruise control feature of the vehicle 100, and for controlling the adaptive cruise control feature. In various embodiments, the controller 105 controls the adaptive cruise control feature via the selection of a driver profile from a plurality of stored driver profiles based on whether other passengers are detected in the vehicle 100 and/or based on a driving history for the current driver of the vehicle 100. The controller 105, along with the sensor array 103 and the transceiver 104, also provide additional functions, such as those discussed further below in connection with the schematic drawings of the vehicle 100 in FIG. 1 and the process 200 of FIG. 2, discussed further below.

As depicted in FIG. 1, the controller 105 comprises a computer system. In certain embodiments, the controller 105 may also include one or more of the sensors of the sensor array 103, one or more other devices and/or systems, and/or components thereof. In addition, it will be appreciated that the controller 105 may otherwise differ from the embodiment depicted in FIG. 1. For example, the controller 105 may be coupled to or may otherwise utilize one or more remote computer systems and/or other control systems, such as the electronic control system 118 of FIG. 1.

In the depicted embodiment, the computer system of the controller 105 includes a processor 172, a memory 174, an interface 176, a storage device 178, and a bus 180. The processor 172 performs the computation and control functions of the controller 105, and may comprise any type of processor or multiple processors, single integrated circuits such as a microprocessor, or any suitable number of integrated circuit devices and/or circuit boards working in cooperation to accomplish the functions of a processing unit. During operation, the processor 172 executes one or more programs 182 contained within the memory 174 and, as such, controls the general operation of the controller 105 and the computer system of the controller 105, generally in executing the processes described herein, such as the process 200 described further below in connection with FIG. 2.

The memory 174 can be any type of suitable memory. For example, the memory 174 may include various types of dynamic random access memory (DRAM) such as SDRAM, the various types of static RAM (SRAM), and the various types of non-volatile memory (PROM, EPROM, and flash). In certain examples, the memory 174 is located on and/or co-located on the same computer chip as the processor 172. In the depicted embodiment, the memory 174 stores the above-referenced program 182 along with one or more stored values 184 (e.g., stored driver profiles, thresholds, and/or other values).

The bus 180 serves to transmit programs, data, status and other information or signals between the various components of the computer system of the controller 105. The interface 176 allows communication to the computer system of the controller 105, for example from a system driver and/or another computer system, and can be implemented using any suitable method and apparatus. In one embodiment, the interface 176 obtains the various data from the sensors of the sensor array 103. The interface 176 can include one or more network interfaces to communicate with other systems or components. The interface 176 may also include one or more network interfaces to communicate with technicians, and/or one or more storage interfaces to connect to storage apparatuses, such as the storage device 178.

The storage device 178 can be any suitable type of storage apparatus, including direct access storage devices such as hard disk drives, flash systems, floppy disk drives and optical disk drives. In one exemplary embodiment, the storage device 178 comprises a program product from which memory 174 can receive a program 182 that executes one or more embodiments of one or more processes of the present disclosure, such as the steps of the process 200 (and any sub-processes thereof) described further below in connection with FIG. 2. In another exemplary embodiment, the program product may be directly stored in and/or otherwise accessed by the memory 174 and/or a disk (e.g., disk 186), such as that referenced below.

The bus 180 can be any suitable physical or logical means of connecting computer systems and components. This includes, but is not limited to, direct hard-wired connections, fiber optics, infrared and wireless bus technologies. During operation, the program 182 is stored in the memory 174 and executed by the processor 172.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 172) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 105 may also otherwise differ from the embodiment depicted in FIG. 1, for example in that the computer system of the controller 105 may be coupled to or may otherwise utilize one or more remote computer systems and/or other control systems.

While the components of the control system 102 (including the sensor array 103, the transceiver 104, and the controller 105) are depicted as being part of the same system, it will be appreciated that in certain embodiments these features may comprise two or more systems. In addition, in various embodiments the control system 102 may comprise all or part of, and/or may be coupled to, various other vehicle devices and systems, such as, among others, the actuator assembly 120, and/or the electronic control system 118.

FIG. 2 is a flowchart of a process 200 for controlling an adaptive cruise control feature for a vehicle, in accordance with an exemplary embodiment. The process 200 can be implemented in connection with the vehicle 100, including the control system 102, of FIG. 1, in accordance with an exemplary embodiment. Also in one embodiment, the adaptive cruise control feature comprises a FSRACC feature of the vehicle 100 of FIG. 1.

As depicted in FIG. 2, the process 200 is initiated at step 201. For example, in various embodiments, the process 200 may be initiated when a driver approaches the vehicle 100 of FIG. 1 (e.g. as detected via communications between the communication device 101 of FIG. 1 and the transceiver 104 of FIG. 1), and/or when the driver enters the vehicle 100, turns on an ignition or other apparatus of the vehicle 100 (e.g. as detected by one or more sensors of the sensor array 103 of FIG. 1) or the like, representing the beginning of a current ignition cycle or vehicle drive for the vehicle 100. In one embodiment, the process 200 continues throughout the ignition cycle or vehicle drive.

A current driver of the vehicle is identified (step 202). In various embodiments, the current driver of the vehicle 100 of FIG. 1 is identified from a plurality of drivers of the vehicle 100 based on data obtained from one or more driver identification sensors 161 of FIG. 1 during the current ignition cycle or vehicle drive. In one embodiment, the current driver is identified by identifying which driver is associated with the communication device (e.g. keyfob) 101 that is currently in use. In certain other embodiments, the current driver is identified via engagement of an input by the driver to identify the driver (e.g. the driver clicking a button to identify himself or herself or identifying oneself on an input screen), determining one or more physical characteristics of the current driver (e.g. fingerprint, height, weight, seat setting preference, or the like) and comparing it to known physical characteristics of the plurality of drivers of the vehicle 100, and so on (e.g., in certain embodiments, the processor 172 of FIG. 1 may compare such values with known corresponding values for different drivers of the vehicle 100 as stored in the memory 174 of FIG. 1).

In addition, passengers are detected in the vehicle (step 203). In various embodiments, one or more passengers (other than the driver) are detected as being within the vehicle 100 (e.g. as sitting in one of the seats of the vehicle 100) via one or more passenger detection sensors 162 of FIG. 1. For example, in certain embodiments, passengers may be detected via one or more seat belt sensors (e.g. that detect the engagement of a seat belt device, such as when the seat belt is buckled or otherwise applied to a passenger) and/or sensors coupled to a passenger seat of the vehicle (e.g. a sensors disposed underneath a passenger seat that detect the presence, e.g. by weight, of a passenger sitting in the passenger seat).

During each ignition cycle or vehicle drive, various driving parameters are monitored (step 204). In various embodiments, the monitored parameters include measures of vehicle speed (e.g. an average vehicle speed, as determined via measurements of one or more accelerometers 163 and/or speed sensors 164 of FIG. 1), a brake pedal history (e.g. measures of how often and/or how quickly the brake pedal is engaged by the driver, as determined via measurements from one or more brake pedal sensors 165 of FIG. 1), a vehicle acceleration history (e.g. measures of how quickly the driver accelerates the vehicle after a stop, as determined via measurements from one or more accelerometers 163 of FIG. 1), a vehicle deceleration history (e.g. measures of how quickly the driver decelerates the vehicle during a stop, as determined via measurements from one or more accelerometers 163 of FIG. 1), a steering angle history (e.g. measures of how quickly or hard the driver turns the steering wheel during a turn, as determined via measurements from one or more steering angle sensors 167 of FIG. 1), and a history of spacing between the vehicle 100 and nearby objects while the driver has been driving the vehicle (e.g. measures of a distance between the vehicle 100 and nearby objects and/or a time separation between the vehicle 100 and nearby objects based on current distance and speed, such as an average “time to collision” spacing value, as determined via measurements from one or more object detection sensors 168).

Driver profiles are generated and/or updated (step 206). In various embodiments, the parameters of step 203 are monitored separately for each driver of the vehicle 100 in order to generate a different and unique driving profile for each of the drivers of the vehicle 100. In one embodiment, the driver profiles are generated during initial drive cycles in which a particular driver is operating the vehicle 100, and are updated in subsequent drive cycles in which the same driver is operating the vehicle.

In one such embodiment, the driver profile can comprise either an “aggressive” driving profile on the one hand, or a “conservative” driving profile on the other hand, depending on the history of the particular driver. For example, a more aggressive driver may drive the vehicle at a relatively faster speed, with more rapid acceleration, deceleration, and turning of the vehicle via engagement of the accelerator pedal, brake pedal, and steering wheel, respectively, and/or with decreased separation between the vehicle 100 and nearby objects, as compared with a more conservative driver. In various embodiments, the driver profile is customized to the particular driver with respect to each of these characteristics.

Also, in one embodiment, multiple, separate driver profiles are generated for each driver based on whether other drivers are detected in the vehicle 100. For example, in one embodiment, (i) a respective first profile is generated for each driver based on the parameters of the driver's operation of the vehicle 100 when no other passengers are in the vehicle 100, and (ii) a respective second profile is generated for each driver based on the parameters of the driver's operation of the vehicle 100 when one or more other passengers are in the vehicle 100. In certain embodiments, more than two driving profiles may be generated for each driver of the vehicle 100 (e.g., based on how many other passengers are detected in the vehicle, and/or whether the passengers are detected in the front or back seats, and/or approximate weights of the passengers, and so on).

The driver profiles are stored in memory (step 208). In one embodiment, the driver profiles are stored in the memory 174 of FIG. 1 as stored values 184 thereof. Also in one embodiment, the driver profiles (including subsequent updates to the driver profiles) are stored in memory for use both in the current drive cycle as well as in future drive cycles.

Additional driver inputs are obtained (step 210). The inputs include a driver's engagement of an adaptive cruise control sensor 169 (e.g. an adaptive cruise control button and/or screen selection sensor, among other possible sensors or other devices). The inputs are used to determine whether the active cruise control feature is active (step 212). In one embodiment, this determination is made by the processor 172 of FIG. 1, and the adaptive cruise control feature is determined to be active if the driver has engaged a button or other indicator so that the adaptive cruise control feature is currently on.

If it is determined that the adaptive cruise control feature is not active, then the process returns to step 202. Steps 202-212 continue until a determination is made that the adaptive cruise control feature is active.

Once it is determined that the adaptive cruise control feature is active, then the adaptive cruise control feature is initiated, and is controlled in a manner that is tailored for the driver. In one embodiment, the adaptive cruise control feature is controlled differently based on whether other passengers are detected in the vehicle, and may be further tailored for the specific driver, for example as described below.

A determination is made as to whether one or more passengers are detected within the vehicle (step 214). In one embodiment, this determination is made by the processor 172 of FIG. 1 based on the passenger detection data from step 203 obtained from the passenger detection sensors 162 of FIG. 1.

If it is determined that there are no additional passengers in the vehicle, then a first driver profile is selected (step 216). Conversely, if it is determined that there are one or more additional passengers in the vehicle, then a second driver profile is instead selected (step 218). The driver profile is preferably selected by the processor 172 of FIG. 1 from the multiple driver profiles stored in the memory 174 of FIG. 1 as stored values 184 thereof.

In one embodiment, the second driver profile of step 218 reflects a more conservative (or less aggressive) profile, and the first driver profile of step 216 includes a more aggressive (or less conservative) profile. For example, the second driver profile of step 218 may include relatively more gradual and/or conservative acceleration and/or deceleration as compared with the first driver profile of step 216, and/or may maintain a relatively greater and/or more conservative spacing between objects and the vehicle as compared with the first driver profile of step 216.

For example, in one embodiment, the vehicle 100 will brake sooner as it approaches a detected object (e.g. within a relatively greater distance and/or time to collision threshold) with the second driver profile of step 218 as compared with the first driver profile of step 216. Also in one embodiment, the vehicle 100 will brake more gradually as it approaches an object (e.g. within a relatively greater distance and/or time to collision threshold) with the second driver profile of step 218 as compared with the first driver profile of step 216. In addition, in one embodiment, the vehicle 100 will accelerate more gradually with the second driver profile of step 218 as compared with the first driver profile of step 216.

In one embodiment, the first driver profile of step 216 and the second driver profile of step 218 may be predetermined profiles, for example as set during manufacturing of the vehicle 100. For example, in one such embodiment, the second driver profile of step 218 represents a relatively more conservative profile for use when any driver uses the adaptive cruise control feature with one or more other passengers in the vehicle 100, and the first driver profile of step 216 represents a relatively more aggressive profile for use when any driver uses the adaptive cruise control feature without any other passengers in the vehicle 100. In certain embodiments, more than two driver profiles may be utilized (for example based on the number of other passengers, the seating position of the other passengers, and so on).

In other embodiments, the first driver profile of step 216 and the second driver profile of step 218 may be further tailored to the particular driver of the vehicle 100. For example, in one such embodiment, the first driver profile of step 216 represents a first profile reflecting a particular driver's prior driving history when no other passengers are in the vehicle 100, and the second driver profile of step 218 represents a second profile reflecting a particular driver's prior driving history when one or more other passengers are in the vehicle 100. In certain embodiments in which multiple drivers may drive the vehicle 100 at different times, each driver will have his or her own respective first and second driver profiles. In certain embodiments, more than two driver profiles may be utilized for each driver (for example based on the driver's history with different numbers of other passengers, different seating position of the other passengers, and so on).

Various other inputs are also obtained in steps 220-224 in accordance with exemplary embodiments. The inputs may include, for example, driver inputs including a requested speed for the vehicle (e.g. as detected by an accelerator pedal sensor 166 of FIG. 1) (step 220), various vehicle parameters, such as a current vehicle speed, acceleration, and/or steering angle (e.g. as measured and/or determined from accelerometers 163, wheel speed sensors 164, and/or steering angle sensors 167) (step 222), and surrounding parameters, such as detected objects, for example by one or more object detection sensors 168 of FIG. 1 (step 224).

The adaptive cruise control feature of the vehicle is controlled using the selected profile (step 226). In one embodiment, step 226 is performed by the processor 172 of FIG. 1 using the selected first profile of step 216 or second profile of step 218 (i.e., depending on whether other passengers were detected in steps 203, 214). Also in one embodiment, the selected profile is implemented in controlling the adaptive cruise control feature using the various additional inputs of step 220-224.

For example, in one embodiment, when an object is detected, the adaptive cruise control feature is controlled so as to provide braking, deceleration, and acceleration in accordance with the properties of the selected driver profile, and in view of the other inputs obtained (e.g. the speed and acceleration of the vehicle, and so on). For example, in one embodiment discussed above, the adaptive cruise control feature is controlled with relatively more conservative braking, acceleration, and deceleration when other passengers are detected in the vehicle. For example, in one embodiment, when an object is detected, braking may occur sooner when an object is detected (e.g. beginning when the object is relatively farther away from the vehicle 100 in terms of distance or potential time to collision) with the second driver profile as compared with the first driver profile. Similarly, in one embodiment, after the object is detected, such braking may occur relatively more gradually and for a relatively longer period of time with the second driver profile as compared with the first driver profile. Likewise, in one embodiment, when the vehicle 100 accelerates (e.g. after a stop, and/or after the object is no longer detected or is sufficiently spaced away from the vehicle 100), the acceleration may occur more gradually and over a relatively longer period of time with the second driver profile as compared with the first driver profile.

By way of further example, in certain embodiments, the adaptive cruise control feature is controlled with braking, acceleration, and deceleration consistent with a prior driving history of the driver that is identified as the current driver of the current ignition cycle or vehicle drive, and that is consistent with the current detection of passengers in steps 203, 214. As discussed above, in certain embodiments, each driver has (i) a respective first driving profile based on a first history of the driver's operation of the vehicle 100 when no other passengers are in the vehicle, as well as (ii) a respective second driving profile based on a second history of the driver's operation of the vehicle 100 when one or more other passengers are in the vehicle.

Accordingly, methods, systems, and vehicles are provided that include controlling an adaptive cruise control feature, such as a FSRACC system, for a vehicle. In one embodiment, different driver profiles are selected based on whether one or more other passengers are detected in the vehicle. Also in one embodiment, different driver profiles are selected based on an identification of the current driver and a prior driving history of the identified driver.

It will be appreciated that the disclosed methods, systems, and vehicles may vary from those depicted in the Figures and described herein. For example, the vehicle 100, the control system 102, and/or various components thereof may vary from that depicted in FIG. 1 and described in connection therewith. In addition, it will be appreciated that certain steps of the process 200 may vary from those depicted in FIG. 2 and/or described above in connection therewith. It will similarly be appreciated that certain steps of the method described above may occur simultaneously or in a different order than that depicted in FIG. 2 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

What is claimed is:

1. A method comprising:
detecting passengers, other than a driver, in a vehicle; and
controlling an adaptive cruise control feature of the vehicle using:
a first profile if no passengers are detected in the vehicle; and
a second profile, different from the first profile, if one or more passengers are detected in the vehicle.

2. The method of claim 1, wherein the second profile provides more conservative braking as compared with the first profile.

3. The method of claim 1, wherein the second profile provides more conservative acceleration as compared with the first profile.

4. The method of claim 1, wherein the second profile provides more conservative spacing between the vehicle and nearby objects as compared with the first profile.

5. The method of claim 1, further comprising:
identifying the driver of the vehicle;
wherein the step of controlling the adaptive cruise control further comprises controlling the adaptive cruise control also using a driving history for the driver.

6. The method of claim 5, wherein:
the first profile is based on a first prior driving history for the driver, the first prior driving history occurring while the driver was driving with no other passengers in the vehicle; and
the second profile is based on a second prior driving history for the driver, the second prior driving history occurring while the driver was driving with one or more other passengers in the vehicle.

7. The method of claim 1, wherein the driving history for the driver comprises one or more of the following: a vehicle speed history, a brake pedal history, a vehicle acceleration history, a vehicle deceleration history, a steering angle history, and a history of spacing between the vehicle and nearby objects while the driver has been driving the vehicle.

8. A method comprising:
identifying a driver of a vehicle;
obtaining a driving history for the driver; and
controlling an adaptive cruise control feature of the vehicle using the driving history for the driver.

9. The method of claim 8, wherein the driving history for the driver comprises a vehicle speed history for the vehicle while the driver has been driving the vehicle.

10. The method of claim 8, wherein the driving history for the driver comprises a vehicle acceleration history for the vehicle while the driver has been driving the vehicle.

11. The method of claim 8, wherein the driving history for the driver comprises a vehicle deceleration history for the vehicle while the driver has been driving the vehicle.

12. The method of claim 8, wherein the driving history for the driver comprises a steering angle history for the vehicle while the driver has been driving the vehicle.

13. The method of claim 8, wherein the driving history for the driver comprises a history of spacing between the vehicle and nearby objects while the driver has been driving the vehicle.

14. The method of claim 8, further comprising:
detecting passengers, other than a driver, in a vehicle;
wherein the step of controlling the adaptive cruise control feature further comprises controlling the adaptive cruise control feature of the vehicle using:
a first profile if no passengers are detected in the vehicle; and
a second profile, different from the first profile, if one or more passengers are detected in the vehicle.

15. The method of claim 14, wherein:
the first profile is based on a first prior driving history for the driver, the first prior driving history occurring while the driver was driving with no other passengers in the vehicle; and
the second profile is based on a second prior driving history for the driver, the second prior driving history occurring while the driver was driving with one or more other passengers in the vehicle.

16. A system comprising:
a sensing unit configured to detect passengers, other than a driver, in a vehicle; and
a processor coupled to the sensing unit and configured to at least facilitate controlling an adaptive cruise control feature of the vehicle using:
a first profile if no passengers are detected in the vehicle; and
a second profile, different from the first profile, if one or more passengers are detected in the vehicle.

17. The system of claim 16, wherein the second profile provides more conservative braking as compared with the first profile.

18. The system of claim 16, wherein the second profile provides more conservative acceleration as compared with the first profile.

19. The system of claim 16, further comprising:
a second sensing unit configured to identify the driver of the vehicle;
wherein the processor is further configured to control the adaptive cruise control also using a driving history for the driver.

20. The system of claim 19, wherein:
the first profile is based on a first prior driving history for the driver, the first prior driving history occurring while the driver was driving with no other passengers in the vehicle; and
the second profile is based on a second prior driving history for the driver, the second prior driving history occurring while the driver was driving with one or more other passengers in the vehicle.
